(19) United States
(12) Patent Application Publication
(10) Pub. No.: US 2013/0091664 A1
(43) Pub. Date: Apr. 18, 2013

(54) Friction Sleeve Caster Assembly

(71) Applicant: Oconomowoc Mfg. Corp., Oconomowoc, WI (US)

(72) Inventor: Scott T. Breyer, Dousman, WI (US)

(73) Assignee: Oconomowoc Mfg. Corp., Oconomowoc, WI (US)

(21) Appl. No.: 13/706,856

(22) Filed: Dec. 6, 2012

Related U.S. Application Data
(63) Continuation of application No. 12/480,657, filed on Jun. 8, 2009.

(51) Int. Cl. B60B 33/00

(52) U.S. Cl. CPC B60B 33/006
USPC 16/20

(57) ABSTRACT

The invention relates generally to a friction sleeve for a caster stem. In certain embodiments, the friction sleeve has a slot, comprises a polymer, and has at least one detent adapted to engage a corresponding detent of the caster stem.

### RELATED APPLICATIONS

The present application is a continuation of U.S. utility application Ser. No. 12/480,657, filed Jun. 8, 2009, the entire contents of which are incorporated herein by reference.

### BACKGROUND

Caster assemblies are well known. They are provided on a wide variety of articles that are moveable by rolling, including chairs and other furniture (tables, sofas, beds, etc.), stands for medical equipment and other instrumentation, cabinets, work surfaces, dollies, and the like. FIG. 1 shows one type of conventional caster assembly 10. Here, the caster assembly 10 includes a wheel 12 that is rotationally coupled to a caster frame 14. The caster frame 14 is coupled to a caster stem 16, which allows the caster assembly 10 to be attached to an article (not shown in FIG. 1) such that the wheel 12 is free to pivot relative to the article.

A caster assembly can be attached to an article in a number of different ways (e.g., with plates and bolts, screws, stems, and/or other fasteners). As with the example shown in FIG. 1, in many cases the caster assembly is mounted to an article by inserting the caster stem 16 into an opening in the article, such as a bore or socket in which the caster stem 16 can be retained.

FIG. 1 illustrates a typical friction ring 20 on a caster stem 16. The caster stem 16 has a small circumferential channel 22 to receive the friction ring. The friction ring 20 has an exterior diameter slightly larger than the interior diameter of the bore. Upon inserting the caster stem 16 into the bore, the friction ring 20 contracts slightly against the pressure of the wall defining the smaller diameter bore. Once in place, the friction ring 20 exerts an outward force on the wall of the bore, to frictionally engage the article and thereby secure the caster assembly 10 to the article.

While the caster assembly 10 shown in FIG. 1 has a relatively simple design, it has a number of significant drawbacks that make it difficult to manufacture and use. For example, the friction ring 20 is typically a metal wire that is difficult to install on the caster stem 16. In some cases, the wire is bent manually (or by machine) and positioned in the channel 22 on the caster stem. In other cases, the ring is preformed and then forced over the end of the caster stem 16. Either way, the small size of the ring, the high strength of the metal, and the small size of the channel make it difficult to mount the friction ring 20 on the caster stem. Moreover, the cost of a machine to mount friction rings on caster stems can be exorbitant.

A caster assembly 10 like that shown in FIG. 1 can also be relatively difficult to install or mount to the desired article. For example, when mounted in a metal chair frame (or any other metal base), the metal-to-metal contact between the friction ring 20 and the metal chair can make insertion (and subsequent removal) difficult. Moreover, metal-to-metal contact between a friction ring 20, a caster stem 16, and a surrounding metal base can make the assembly susceptible to corrosion, which can cause the caster to seize. Short of fully locking, such metal-to-metal contact can add significant resistance to the desired pivoting motion of the caster. This reduces performance. Further, the metal-to-metal contact yields a noisy assembly. Still further, many caster assemblies with metal-to-metal contact require lubrication to achieve acceptable performance. Finally, it can be difficult to consistently achieve proper alignment of friction rings on caster stems. If a friction ring is not properly aligned on a caster stem, it can be difficult or virtually impossible to mount the caster stem in a caster bore. Thus, conventional friction rings have a number of significant drawbacks.

### SUMMARY

In certain embodiments, the invention provides a friction sleeve for a caster stem. The friction sleeve preferably comprises a polymer. In the present embodiments, the friction sleeve has a generally cylindrical interior configuration and defines a slot, which optionally extends along an axis that is at least generally parallel to a central axis of the friction sleeve's generally cylindrical configuration. The friction sleeve comprises a wall adapted to at least partially encapsulate the caster stem, and the friction sleeve has at least one detent adapted to engage a corresponding detent of the caster stem.

Some embodiments of the invention provide a friction sleeve for a caster stem. In the present embodiments, the friction sleeve consists essentially of a generally cylindrical wall adapted to encapsulate substantially the entire caster stem, and the wall comprises a polymer and a filler. Here, the wall defines a slot extending along an entire length of the friction sleeve and along an axis that is at least generally parallel to a central axis of the friction sleeve, and the wall has a rib projecting radially inward and being adapted to engage a channel formed in the caster stem.

Certain embodiments provide a caster assembly comprising at least one wheel, a metal caster stem, and a friction sleeve. In the present embodiments, the friction sleeve comprises a polymer and has a wall at least partially encapsulating the caster stem. The wall has a generally cylindrical interior configuration and defines a slot, which optionally extends along an axis that is at least generally parallel to a central axis of the caster stem. In the present embodiments, the caster stem and the friction sleeve have engaged detents securing the friction sleeve on the caster stem.

The invention, in some embodiments, provides an article movable by rolling. The article comprises a base having a caster bore, and a caster assembly. In the present embodiments, the caster assembly comprises at least one wheel, a frame member, a metal caster stem, and a friction sleeve. Preferably, the friction sleeve comprises a polymer and has a wall at least partially encapsulating the caster stem. The wall has a generally cylindrical interior configuration and defines a slot, which optionally extends along an axis that is at least generally parallel to a central axis of the caster stem. In the present embodiments, the caster stem and the friction sleeve have engaged detents rotatably securing the friction sleeve on the caster stem, and the resulting sleeve-encapsulated caster stem is received in the caster bore so as to removably secure the caster assembly to the base.

In certain embodiments, the invention provides an article movable by rolling. The article includes a base having a caster bore, and a caster assembly. In the present embodiments, the caster assembly comprises at least one wheel, a frame member, a metal caster stem, and a friction sleeve. Preferably, the friction sleeve comprises a polymer and has a wall at least partially encapsulating the caster stem. The wall has a generally cylindrical interior configuration and defines a slot, which optionally extends along an axis that is at least generally parallel to a central axis of the caster stem. In the present embodiments, the caster stem and the friction sleeve have engaged detents securing the friction sleeve on the caster stem, and the resulting sleeve-encapsulated caster stem is received in the caster bore such that the friction sleeve directly engages the base so as to removably secure the caster assembly to the base. Here, the caster stem is devoid of any metal friction ring.

### BRIEF DESCRIPTION OF THE DRAWINGS

The following drawings are illustrative of particular embodiments of the present invention and therefore do not limit the scope of the invention. The drawings are not necessarily to scale and are intended for use in conjunction with the explanations in the following detailed description. Embodiments of the present invention will hereinafter be described in conjunction with the appended drawings, wherein like numerals denote like elements.

FIG. 1 is a perspective view of a prior art caster assembly.

FIGS. 2A and 2B are perspective views of caster assemblies according to embodiments of the invention.

FIGS. 3A-3E are various views of a friction sleeve according to an embodiment of the invention.

FIG. 4A is a side elevation view of a caster stem; FIG. 4B is a side elevation view of a friction sleeve mounted on the caster stem of FIG. 4A according to an embodiment of the invention; and FIG. 4C is a cross-sectional view of FIG. 4B.

FIG. 5A is a perspective view of a caster assembly mounted to a base according to an embodiment of the invention; FIG. 5B is a cross-sectional view of FIG. 5A according to an embodiment of the invention.

FIG. 6 is a perspective view of a friction sleeve including fins according to an embodiment of the invention.

FIG. 7 is a perspective view of a friction sleeve including fins according to an embodiment of the invention.

FIG. 8A is a perspective view of a caster assembly mounted to a base according to an embodiment of the invention.

FIG. 8B is a cross-sectional view of FIG. 8A in which the caster assembly is mounted to the base by virtue of a caster socket according to an embodiment of the invention.

FIG. 8C is a cross-sectional view of FIG. 8A in which the caster assembly is mounted to the base by virtue of a finned friction sleeve (but no caster socket) according to an embodiment of the invention.

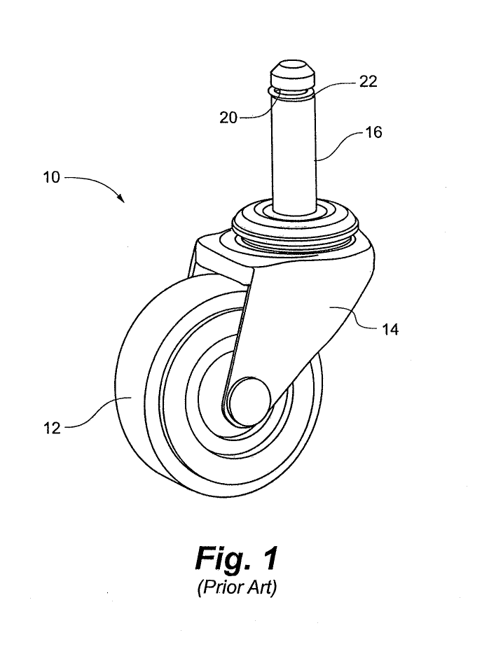

### DETAILED DESCRIPTION OF PREFERRED EMBODIMENTS

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

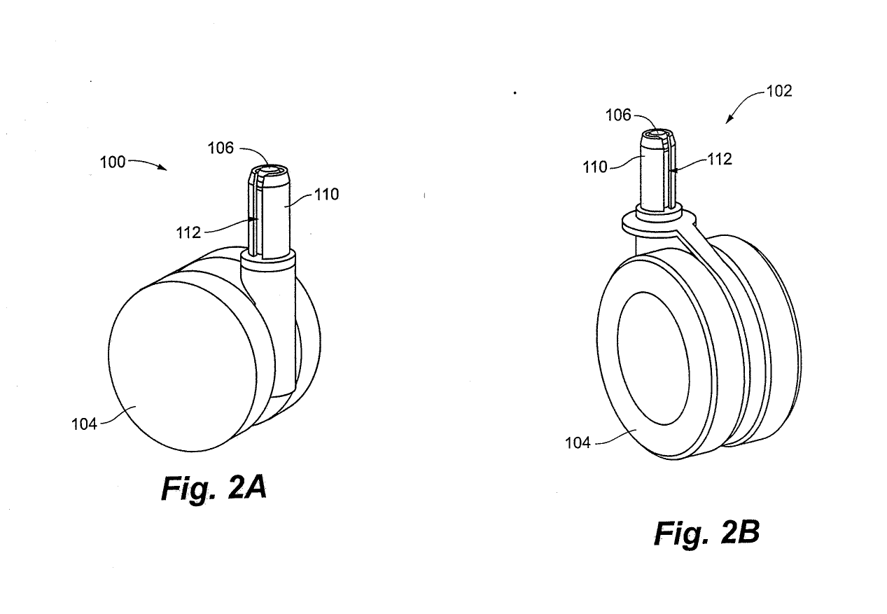

FIGS. 2A and 2B are perspective views of different caster assemblies 100, 102 according to certain embodiments of the invention. The caster assemblies 100, 102 generally include at least one wheel 104 coupled with a caster stem 106, which allows the wheel(s) to be pivotably coupled with an article, such as the base of a chair (not shown in FIGS. 2A and 2B). As illustrated in FIGS. 2A and 2B, the caster assembly 100, 102 includes a friction sleeve 110 at least partially encapsulating the caster stem 106. The friction sleeve preferably comprises a polymer. More will be said of this later. In some cases, the friction sleeve 110 defines a slot 112 extending along a side of the friction sleeve 110. The sleeve-encapsulated caster stem 106 can be mounted in a caster bore of a base to couple the caster assembly to the base.

The “caster bore” is the opening into which the sleeve-encapsulated caster stem is mounted. The caster bore need not be formed by drilling or any other particular method. Nor must it be round in cross section. Moreover, the caster bore can be defined by the base or by a caster socket.

As described below in further detail, the friction sleeve 110 is adapted to retain the caster stem 106 in the caster bore through frictional engagement with the surrounding base (or with a caster socket mounted to the base). In certain embodiments, interlocking detents of the friction sleeve 110 and caster stem 106 couple and secure the stem 106 and sleeve 110 together. Thus, in preferred embodiments, the friction sleeve 110 securely couples the caster stem 106 to the base. In some embodiments, the friction sleeve holds the caster stem to the base securely enough that if the base is lifted off the ground, the caster will not fall from the base (but rather is retained on the base). In such embodiments, the force required to remove the caster assembly from the base is greater than the weight of the caster assembly.

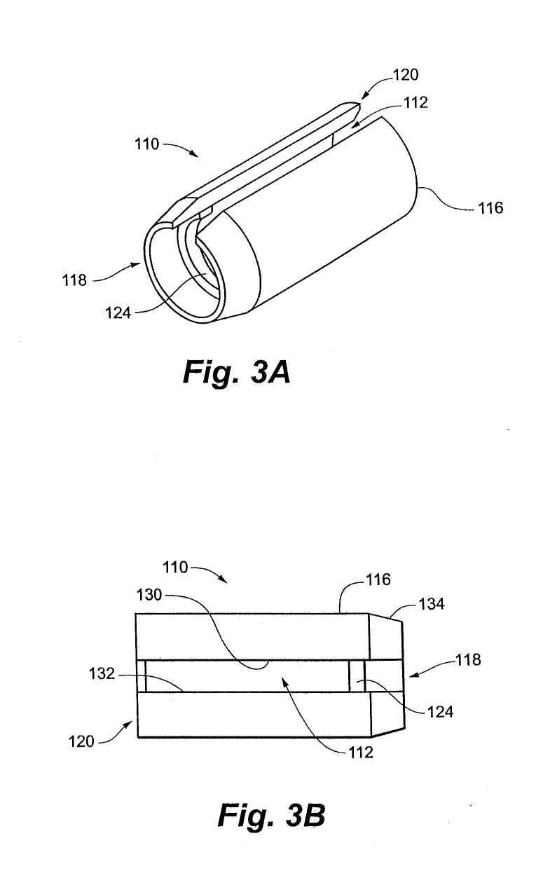

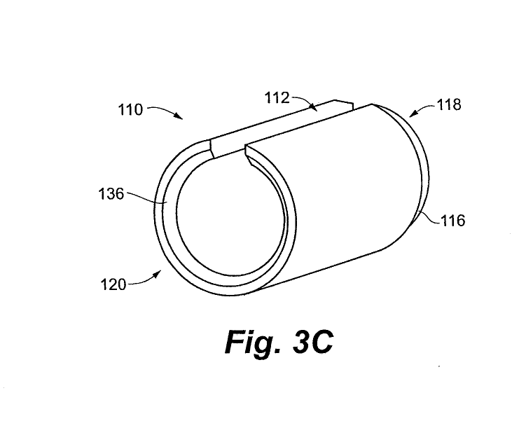

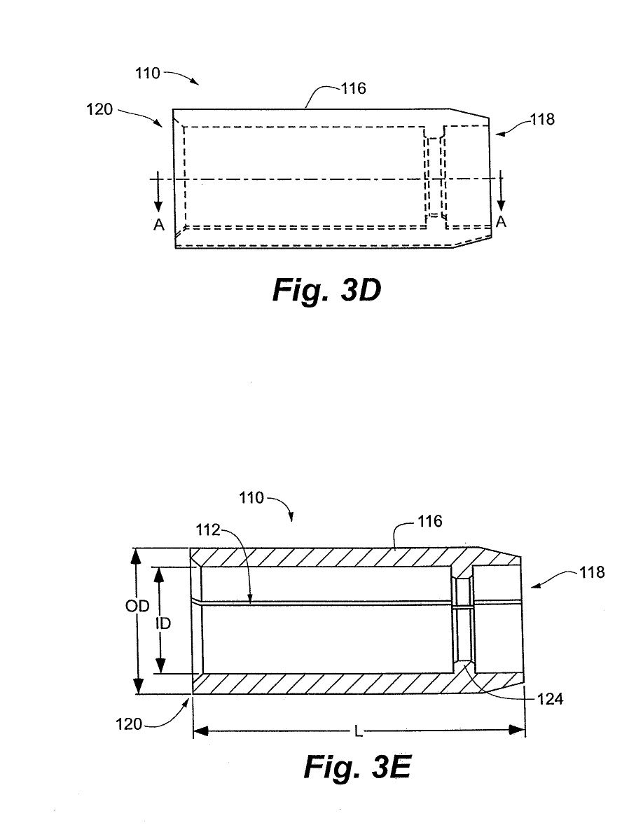

FIGS. 3A-3E illustrate various views of one example of the friction sleeve 110 shown in FIGS. 2A and 2B according to certain embodiments of the invention. Here, the friction sleeve has a generally-cylindrical configuration. This, however, is not strictly required in all embodiments. In many cases, though, the friction sleeve will at least have a generally cylindrical interior configuration, such that the sleeve is adapted to fit onto a generally cylindrical caster stem. The friction sleeve 110 of FIGS. 3A-3E comprises a wall 116 having a generally cylindrical configuration, which is centered on a central axis. The friction sleeve has a first end 118 and a second end 120, and a length of the sleeve extends between the first and second ends. In the illustrated embodiment, the wall 116 defines the friction sleeve's slot 112, which is shown extending along an axis that is at least generally parallel to the central axis of the sleeve 110. In the illustrated embodiment, the slot is substantially parallel to the sleeve's central axis. This, however, is not required. For example, the slot can alternatively be slanted relative to the central axis, or it can have a curved configuration.

In the illustrated embodiments, the friction sleeve 110 includes a detent 124 adapted to cooperate with a corresponding detent on the caster stem to secure the friction sleeve 110 on the caster stem. Exemplary detents are described below in further detail.

Referring to FIG. 3B, the illustrated slot 112 is defined by two confronting edges 130, 132 of the wall 116. According to certain embodiments, the slot 112 extends along the entire length of the friction sleeve 110, i.e., the slot extends entirely between the first and second ends 118, 120 of the friction sleeve. For example, the illustrated slot is open to both the open top and the open bottom of the friction sleeve. In some embodiments, the slot is formed only in a single side of the friction sleeve 110. For example, the slot 112 can optionally extend along one side of the friction sleeve's generally cylindrical wall 116, without extending into an opposite side of the cylindrical wall. Thus, the friction sleeve can be a cylinder (optionally having an open bottom and an open top) with a slot in only one side of the cylinder. Other configurations for the slot are possible. For example, the edges defining the slot need not be parallel to each other. Instead, one can be slanted relative to the other. The slot can optionally have a width that varies at different locations along the length of the sleeve. For example, the slot can be wider near the ends 118, 120 of the sleeve than at the middle of the sleeve. Many variations of this nature are possible. In the illustrated embodiment, though, the width of the slot is the same (or substantially the same) all the way along the length of the friction sleeve.

The configuration of the illustrated slot 112 provides the friction sleeve 110 with a degree of flexibility, allowing the sleeve to expand and contract to an extent. Thus, the friction sleeve in certain embodiments is characterized by having a diameter (and/or perimeter) that decreases or increases, respectively, in response to the sleeve being contracted or expanding after it has been contracted. In some embodiments of this nature, when the diameter (and/or perimeter) of the sleeve is reduced, the width of the slot 112 simultaneously becomes smaller, and when the diameter (and/or perimeter) of the sleeve increases, the width of the slot 112 simultaneously becomes larger.

The ability of the friction sleeve to contract and expand provides a number of advantages. For example, when the sleeve 110 is mounted on a caster stem (see FIGS. 2A and 2B), the diameter (and/or perimeter) of the sleeve 110 can expand as the sleeve is pressed down in an axial direction over the top of the caster stem to allow the sleeve to slide easily into place. In an alternate embodiment, the sleeve is sufficiently flexible that it can be pressed onto the caster stem in a radial direction (e.g., from the side), with the slot expanding sufficiently to allow the caster stem to pass through the slot.

In addition, the flexibility of the friction sleeve allows it to be inserted into a caster bore having an interior dimension (e.g., an interior diameter) that is smaller than a normal exterior dimension (e.g., an exterior diameter) of the friction sleeve (when the friction sleeve is at rest, i.e., when it is in a non-deformed state, at which point it assumes its “default” diameter and/or perimeter). As the friction sleeve 110 is inserted into the bore, the sleeve contracts such that its exterior diameter and/or perimeter decreases and thereby fits into the smaller bore.

In certain embodiments, the friction sleeve 110 includes additional structural features that allow the sleeve to be more easily mounted on a caster stem, within a caster bore, or both. Referring to FIG. 3B, in certain embodiments the friction sleeve has a tapered leading end region 134, which can optionally define the first end 118 of the friction sleeve. In some cases, this leading end region 134 includes a beveled or chamfered edge that facilitates inserting the friction sleeve 110 into the caster bore. Turning to FIG. 3C, in certain embodiments, the friction sleeve includes a tapered trailing end region 136. This end region 136 can include a beveled or chamfered edge, tapering inwardly from the outside surface to the inside surface of the friction sleeve's wall 116. When provided, the tapered trailing end region 136 can facilitate mounting the friction sleeve on the caster stem.

According to certain embodiments, the friction sleeve 110 has a polymeric composition, i.e., it comprises a polymer. The friction sleeve can be made by injection molding, extrusion, or any other suitable manufacturing process. In some cases, the friction sleeve 110 comprises a polymer including or consisting essentially of acetal. Acetal is desirable because it is self-lubricating. Thus, the friction sleeve can advantageously comprise a polymer that has inherent lubricity. More generally, though, many polymers can be used, such as nylon, polypropylene, ABS, and UHMW. Preferably, the polymeric composition gives the friction sleeve 110 a flexibility that enables it to expand and contract in the manner described above.

The polymeric composition can also provide the friction sleeve 110 with a degree of resiliency. For example, when the sleeve-encapsulated caster stem is inserted into a caster bore having an interior dimension (e.g., diameter) smaller than an exterior dimension (e.g., diameter) of the friction sleeve, the diameter and/or perimeter of the sleeve will be reduced during insertion. However, the resiliency of the polymeric composition causes the sleeve to “spring back” to its original form (or as close to its original form as possible given the size of the bore). Thus, as the friction sleeve 110 is inserted into the bore of a base, the sleeve is able to contract (e.g., due to its slot 112) so as to decrease its outside diameter and/or perimeter and fit into the smaller bore. Once inserted, the resiliency of the friction sleeve 110 urges it toward its original form (or as close as possible given the bore's size) such that the sleeve bears forcefully against the surface defining the bore. Thus, the resiliency of the friction sleeve keeps it in frictional engagement with the base (or with a caster socket mounted to the base), thereby strengthening the coupling between the caster assembly and the base.

According to certain embodiments, the polymer of the friction sleeve 110 includes a filler, e.g., to increase the resilience of the friction sleeve 110. In some embodiments, a glass filler is added to the polymer to strengthen the sleeve, to increase its resilience, or both. Other fillers may be used. In certain embodiments, a glass fill of about 5-45% by weight is used, such as about 5-35%, or 10-30%. In addition to increased resilience and/or strength, the filler can optionally increase the surface roughness of the friction sleeve. Increased surface roughness can enhance the frictional engagement of the sleeve and the base or socket, thus strengthening the retention of the caster assembly to the base. Moreover, the filler can advantageously provide the friction sleeve with the ability to resist taking a set (e.g., the filler can provide the polymer with a desirable level of creep resistance). Thus, the friction sleeve can advantageously be provided with a relatively permanent resilience.

If desired, the friction sleeve could alternatively be formed of a polymer-based nanocomposite, such as one comprising carbon nanotubes.

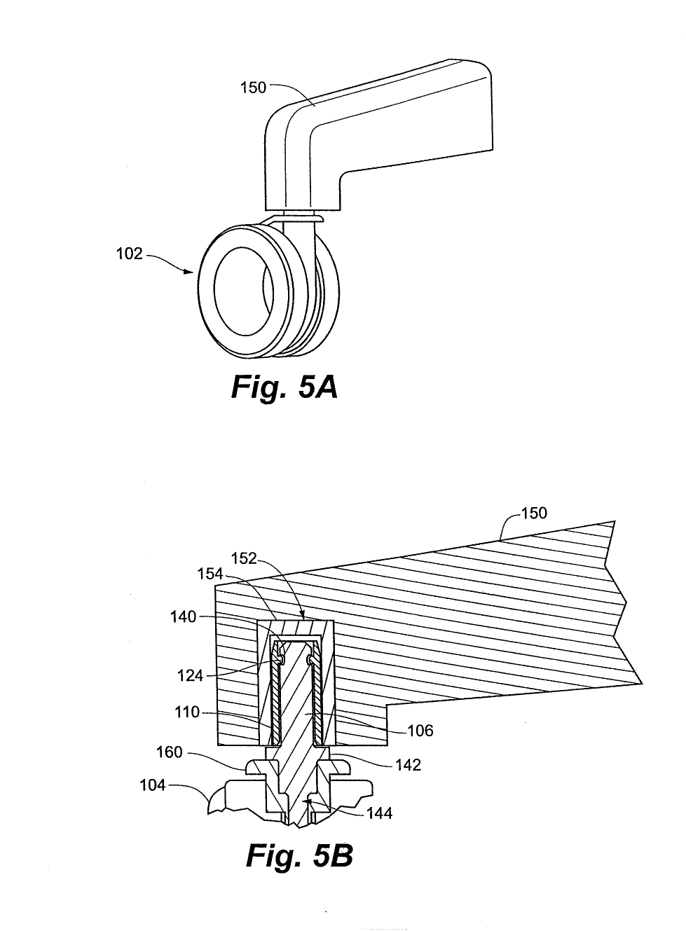

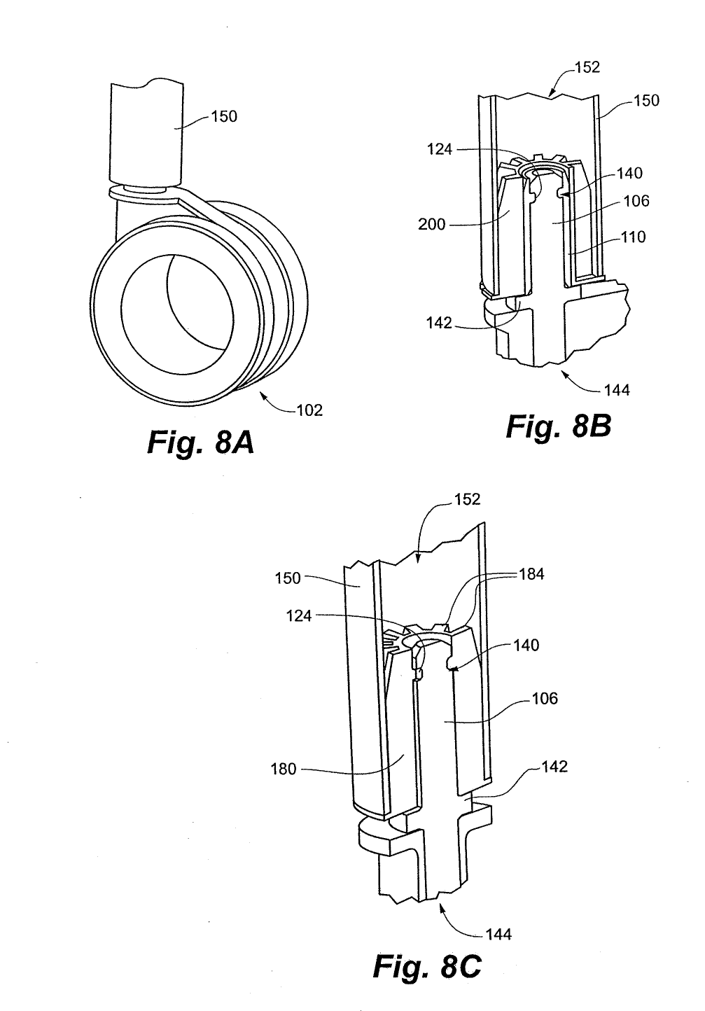

Thus, adding filler to the polymer can make the friction sleeve less susceptible to permanent deformation. For example, the friction sleeve 110 may be repeatedly inserted and removed from a caster bore that is smaller than the friction sleeve (see, e.g., FIGS. 5B, 8B-8C). Yet, in some embodiments, due to the composition and configuration of the sleeve, little or none of its resiliency is lost. Instead, each time such a sleeve is contracted, it returns to its original form after subsequently being released. Thus, the friction sleeve in these embodiments is capable of repeated and effective use over time.

In contrast, plastic caster sockets typically rely on permanent deformation to provide the required degree of frictional engagement between the caster socket and a base. For example, caster stems are sometimes mounted in a plastic caster socket having outwardly extending ribs. When the caster socket is hammered into an opening of the base, the ribs of the socket deform. Later, if the socket is removed from the base, the deformation persists (at least to some extent), potentially rendering the socket useless. If one attempts to install the same socket in the base later, the deformed socket ribs will not engage the base with the same strength. In contrast, certain embodiments of the present invention provide strong engagement to the base even after numerous insertions and removals of the caster assembly. Further, in comparison with embodiments of the present invention in which the friction sleeve has a slot, caster sockets with no slot do not have the same ability to expand and contract.

According to certain embodiments, the resiliency of the friction sleeve 110 also increases its ability to withstand the wear and fatigue encountered during ordinary use. After sustained periods of use, some conventional caster assemblies may deteriorate due to fatigue stresses and wear. One result may be loosening of the connection between the caster assembly and the base. In contrast, according to certain embodiments of the present invention, a caster assembly provided with the present friction sleeve 110 meets the standard acceptance levels defined in ANSI/BIFMA X5.1-2002, the contents of which are incorporated herein by reference. In certain embodiments, the friction sleeve 110 provides a frictional engagement with the base (or a socket mounted to the base) such that a removal force of at least 5 lbf is required to separate the sleeve-encapsulated caster stem from the base. In some embodiments, a removal force of at least 5 lbf is required to separate the sleeve-encapsulated caster stem from the base even after subjecting the caster assembly to a durability test as defined in ANSI/BIFMA X5.1-2002, Section 17.

In certain embodiments, the friction sleeve is adapted to provide a removal force of at least about 9 lbf, or at least about 12 lbf. In one group of embodiments, the removal force is between about 5 lbf and about 50 lbf, such as between about 10 lbf and about 45 lbf.

FIG. 3D illustrates a side view of one embodiment of the friction sleeve 110, with the interior configuration of the sleeve being shown in dashed lines. FIG. 3E is a cross-section of FIG. 3D along line AA. As shown in FIG. 3E, the friction sleeve 110 has a length, L, which extends between the first and second ends 118, 120. According to certain embodiments, the friction sleeve 110 has a length L of less than about 5 inches, less than about 3 inches, or less than 2 inches, such as less than 1½ inches. The illustrated sleeve has an interior diameter, ID, and an exterior diameter, OD. In certain embodiments, the friction sleeve 110 has an interior diameter ID of less than about 1 inch, less than 0.7 inch, or less than 0.5 inch. In certain embodiments, the friction sleeve 110 also has an exterior diameter OD that is less than 1 inch, less than 0.7 inch, or less than 0.5 inch. It is to be understood, however, that the friction sleeve is scalable. Thus, its dimensions can be varied to meet the requirements of different caster applications.

In certain embodiments, the friction sleeve has a wall thickness of less than 0.25 inch, less than 0.2 inch, or even less than 0.1 inch, such as less than 0.075 inch. The wall thickness, however, can be varied to accommodate different applications. Therefore, the noted wall thickness ranges (like all other exemplary dimensions mentioned herein) are by no means limiting to the invention.

One exemplary embodiment provides a friction sleeve having the configuration shown in FIGS. 3A-3E where the wall 116 is formed of acetal containing about 20-30% glass filler, and the length of the sleeve is about 1 inch, the exterior diameter is about ½ inch, the interior diameter is about 0.45 inch, and the wall thickness is about 0.05 inch. This friction sleeve is adapted for use in a conventional 7/16 inch caster bore.

According to certain embodiments, the friction sleeve 110 and the caster stem to which it is mounted have corresponding detents that engage one another to secure the friction sleeve on the caster stem. Optionally, when the detents are engaged, the friction sleeve is secured to the caster stem such that the sleeve and the stem are free to rotate relative to each other. Referring to FIGS. 3A, 3B, and 3E, in certain embodiments the friction sleeve 110 includes at least one male detent 124 adapted to engage a channel formed in the caster stem. The detent 124 of the illustrated friction sleeve projects radially inward from the wall 116 (towards a central axis of the sleeve 110). In some cases, the detent 124 is a rib, which can optionally extend entirely about an interior circumference of the wall 116. As an alternative, a series of inwardly projecting bumps (or separate, spaced-apart ribs) can be provided. In other cases, barbs or threads can be used.

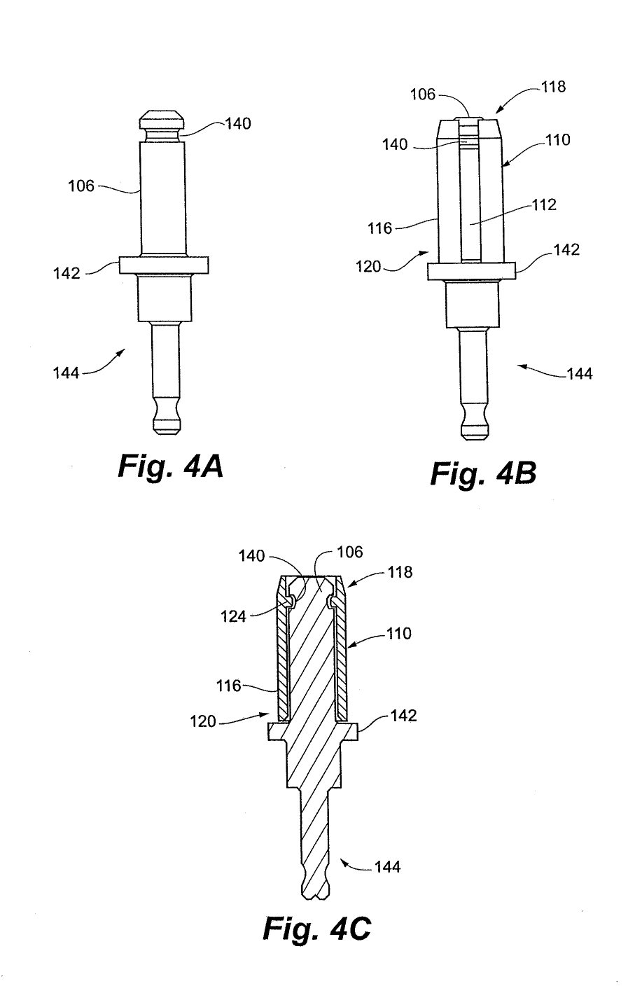

Turning to FIG. 4A, a side view of an exemplary caster stem 106 is illustrated. Here, the caster stem 106 includes a female detent in the form of a channel 140, which is adapted to receive the friction sleeve's male detent 124 when the friction sleeve 110 is mounted on the caster stem. The illustrated channel 140 extends entirely about the circumference of the caster stem, although this is not strictly required. Thus, certain embodiments involve the friction sleeve having a male detent while the caster stem has a female detent. Alternatively, the situation can be reversed. Or, there can be both male and female detents on the sleeve, the stem, or both. Many other variants will be apparent to skilled artisans given the present teaching as a guide.

The illustrated caster stem 106 extends from an optional collar 142, on the other side of which there is an optional coupling pin 144 that allows the caster stem 106 to be coupled to a frame member (see FIGS. 2A and 2B) or other body of the caster assembly. In the other embodiments, the caster stem is an integral part of the frame member or other body of the caster assembly.

In the embodiment of FIGS. 4B and 4C, the caster stem 106 is positioned within the friction sleeve 110 such that detent(s) 124 of the sleeve extend into a channel 140 of the stem. Here, the engagement of the male detent(s) 124 and the channel 140 secure the friction sleeve on the caster stem 106, while allowing the stem and sleeve to rotate freely relative to each other. Thus, once the sleeve-encapsulated caster stem is mounted to a base, the caster 100, 102 is free to pivot relative to the base.

In certain embodiments, once the friction sleeve has been mounted on the caster stem (resulting in a “sleeve-encapsulated caster stem”), the sleeve is rotatably connected to the stem in semi-permanent manner, optionally such that the sleeve cannot be separated from the stem by hand, and/or without breaking at least one detent(s) connecting the sleeve to the stem. In some embodiments of this nature, the friction sleeve (once secured to the caster stem) requires removal by a tool-assisted removal operation.

According to certain embodiments, the caster stem 106 comprises metal. Referring to FIGS. 4B and 4C, in certain embodiments the friction sleeve 110 comprises a polymer and partially encapsulates the caster stem 106. In some preferred embodiments, the friction sleeve encapsulates substantially the entire caster stem 106. For example, the illustrated friction sleeve covers the caster stem entirely except at the sleeve's slot and open top. The illustrated sleeve is thus configured to prevent any contact between the caster stem and the base (or a caster socket mounted to the base), even though the sleeve has the slot and the open top.

By encapsulating at least part of the caster stem 106, the friction sleeve 110 can minimize (or, more preferably, prevent any) contact between the caster stem 106 and a surrounding base (or a caster socket mounted to the base). Thus, when the caster stem and the surrounding base are both formed of metal, or when a metal socket is used, the friction sleeve 110 can minimize or completely prevent metal-to-metal contact between the caster stem and the base or socket. In certain embodiments, a polymeric friction sleeve 110 and a metal caster stem 106 provide a superior bearing connection that requires no lubrication. Moreover, the caster stem preferably is devoid of any metal friction ring.

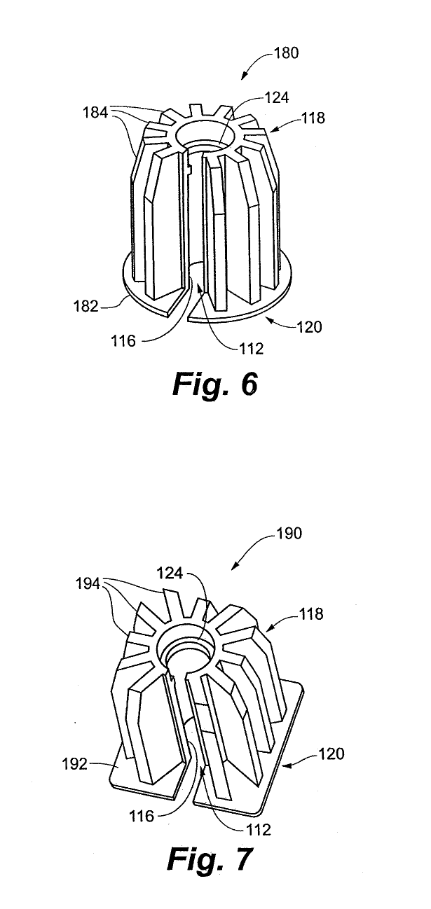

The friction sleeve can take a variety of configurations and shapes. As one example, the friction sleeve can optionally have fins (e.g., fins projecting radially outward) such as those shown in FIGS. 6 and 7. Returning to FIGS. 3A-3E, in certain embodiments an easy-to-manufacture, simple, and inexpensive friction sleeve consists essentially of a single wall 116 or body having a generally cylindrical configuration. Here, the single body includes two confronting edges defining the slot 112 and at least male detent 124 (optionally a rib extending entirely about an interior perimeter of the body). Alternatively, the sleeve can have a channel or another type of female detent. The sleeve can be made from a variety of materials, but in some cases consists essentially of a polymer and a filler. In certain embodiments, the sleeve consists essentially of a glass-filled polymer, such as glass-filled acetal.

FIGS. 5A and 5B are perspective and cross-sectional views, respectively, of a caster assembly 102 installed in a base 150, which in this example is a leg of a chair. The base 150 can be part of virtually any structure that would benefit from having the ability to roll on casters. As shown in FIG. 5B, the base 150 includes a bore (or opening) 152 that receives the sleeve-encapsulated caster stem 106, 110. In certain embodiments, a socket 154 is provided so as to define the caster bore. When provided, the socket 154 is located between the base 150 and the sleeve-encapsulated caster stem. The friction sleeve, however, makes it possible to entirely eliminate the use of a separate caster socket. Thus, in some embodiments, the friction sleeve 110 directly engages the base 150 (i.e., without there being any caster socket 154 between the base and the sleeve-encapsulated caster stem). As noted above, extending from the caster stem 106 is an optional collar 142 and an optional coupling pin 144, which when provided couples the caster stem 106 to a frame 160 coupled to at least one wheel 104. Here again, the caster stem (and the illustrated assembly) is devoid of any metal friction ring, thus simplifying the assembly.

According to certain embodiments, the socket 154, or the base 150 (when no socket 154 is used) defines a caster bore (or opening) having an interior diameter (and/or perimeter) smaller than an exterior diameter (and/or perimeter) of the friction sleeve 110 in a resting (i.e., default) state. As noted above, the friction sleeve preferably has a degree of flexibility and resiliency, allowing the diameter (and/or perimeter) of the sleeve's wall to expand and contract to an extent. Referring to FIG. 5B, the flexibility of the sleeve's wall can allow insertion of the sleeve 110 into the smaller bore. As the friction sleeve 110 is inserted into the bore, the sleeve contracts such that its outside diameter (and/or perimeter) decreases, thereby enabling the sleeve to fit into the smaller bore. Once in the bore, the resiliency of the sleeve 110 urges it forcefully against the surface defining the bore. Thus, the resiliency of the friction sleeve 110 keeps it in frictional engagement with the base 150 (or with a socket mounted in the base), thus rotatably coupling the caster assembly 102 to the base 150.

The flexibility and resiliency of the friction sleeve 110 can compensate for an inadequate or inaccurately formed bore in the base 150 or socket 154. In some cases, the caster bore may be larger or smaller than specified. Because the friction sleeve 110 can expand and contract, it can compensate for an inferior base and provide exceptional coupling between the base 150 and the caster assembly 102.

As noted above, the friction sleeve 110 partially encapsulates the caster stem 106, optionally so as to prevent contact between the caster stem 106 and the surrounding base or socket. According to certain preferred embodiments, the friction sleeve 110 encapsulates substantially the entire caster stem 106. Returning to FIGS. 4B and 4C, as just one example, the friction sleeve 110 in some embodiments extends from the collar 142 to adjacent the top of the caster stem 106. In certain embodiments, the first and second ends 118, 120 of the friction sleeve 110 are both open. As shown in FIG. 4B, the caster stem 106 may protrude slightly above the first end 118 of the friction sleeve 110. However, the illustrated sleeve still prevents contact between the caster stem and the surrounding base or socket (e.g., due to the top of the caster stem being spaced from the walls of the caster bore). Reference is made to FIG. 5B, where according to certain embodiments, the friction sleeve 110 prevents contact between the caster stem 106 and the surrounding base 150 or socket 154; here, the friction sleeve 110 encapsulates substantially the entire length of the caster stem 106. The base 150 or socket 154 may contact the collar 142 or frame 160, but in these embodiments there is no contact between the caster stem 106 and the surrounding base or socket. Thus, when the surrounding base includes metal, or when a metal socket is used, the friction sleeve 110 can advantageously be configured to prevent any metal-to-metal contact (e.g., between the caster stem and the base or socket), thus reducing the friction, corrosion problems, and noise associated with conventional caster assemblies that have metal-to-metal contact.

Turning now to FIGS. 6 and 7, according to some embodiments the friction sleeve can include a number of fins projecting outwardly from the sleeve wall. FIG. 6 is a perspective view of a friction sleeve 180 that includes a circular flange 182 and a number of fins 184 projecting radially outward from the sleeve wall 116 (the illustrated fins extend between the wall 116 and the flange 182). As shown in FIG. 6, the friction sleeve 180 has a generally cylindrical interior configuration defined by the sleeve wall 116. The outer edges of the fins 184 collectively define a generally cylindrical exterior configuration, which has a larger diameter than the sleeve wall 116.

FIG. 7 depicts a friction sleeve 190 having a square-shaped flange 192 and a number of fins 194 projecting radially outward from the sleeve wall 116. Here again, the friction sleeve 190 has a generally cylindrical interior configuration (defined by the sleeve wall 116). However, the outer edges of the fins 194 collectively define a generally polygonal exterior configuration.

According to certain embodiments, these friction sleeves 180, 190 can be useful in applications where a caster assembly is mounted in a base without using any caster socket. In certain embodiments, the fins are formed integrally with the sleeve wall and flange, which in some cases all comprise a filled polymer, such as a glass-filled polymer. In such cases, the friction sleeves 180, 190 have a composition and configuration that provide increased flexibility and resiliency, allowing for repeated insertion and removal to and from a base without adversely affecting the sleeve's ability to firmly engage the base. Note that the friction sleeve design here includes a slot 112 (optionally extending along the entire length of the sleeve), which provides the above-noted ability to expand or contract so as to increase or decrease an exterior dimension (e.g., a diameter and/or perimeter) of the sleeve. In certain embodiments, the interior configuration of the sleeve 180, 190 is generally cylindrical, e.g., so as to be configured to receive a cylindrically-shaped caster stem. The exterior configuration of the sleeve can be designed to fit in a number of different shaped openings. The cylindrical and polygonal exterior configurations shown in FIGS. 6 and 7 are merely two examples.

Turning now to FIG. 8A, a perspective view is shown of a caster assembly 102 mounted to a base 150, which in this case includes a cylindrical support leg. The base 150 can be part of (or coupled to) virtually any article movable by rolling such as, for example, furniture, stands, cabinets, work surfaces, dollies, and many other structures.

FIG. 8B illustrates a cross-section of FIG. 8A according to certain embodiments that include a caster socket 200. The caster socket 200 can comprise metal or plastic, and in some cases may become permanently deformed when inserted into the bore 152 defined by the base 150. Plastic caster sockets are commonly hammered into the base, in the process collapsing the ribs of the socket somewhat. In this example, the socket 200 is mounted in the bore 152, thus providing a smaller diameter caster bore to receive the sleeve-encapsulated caster stem. As depicted, the sleeve-encapsulated caster stem 106 can be inserted in the caster bore of the socket 200 to removably secure the caster assembly 102 to the base 150. Thus, in some embodiments, the friction sleeve is located between (and contacts both) a caster socket and the caster stem.

FIG. 8C illustrates a cross-section of FIG. 8A according to certain embodiments wherein the socket is eliminated and a friction sleeve 180 like that shown in FIG. 6 is provided. This type of assembly provides a simplified design, as the caster stem is retained on the base without needing any caster socket. Here, the sleeve-encapsulated caster stem is mounted in the caster bore 152 to removably secure the caster assembly 102 to the base 150. In embodiments of this nature, the friction sleeve 180 alone provides a secure engagement of the caster stem 106 in the caster bore 152 without needing a caster socket. In such cases, the friction sleeve is located between, and contacts both, the base and the caster stem. Here again, the caster stem (and the illustrated assembly) is devoid of any metal friction ring.

Thus, embodiments of the invention are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention and the scope of the appended claims.

What is claimed is:

1. An article movable by rolling, the article comprising:
a base having a bore;
a caster socket mounted in said bore, the caster socket having a caster bore; and
a caster assembly, the caster assembly comprising at least one wheel, a frame member, a caster stem, and a friction sleeve, the friction sleeve defining a first end and a second end between which extends an axial length of the friction sleeve, the first and second ends of the friction sleeve both being open, the friction sleeve comprising a polymer and encapsulating substantially the entire axial length of the caster stem, such that the friction sleeve prevents contact between the caster stem and the caster socket, the friction sleeve having a generally cylindrical interior configuration and defining a slot, the slot extending along the entire axial length of the friction sleeve, the caster stem and the friction sleeve having engaged detents rotatably securing the friction sleeve on the caster stem, and the resulting sleeve-encapsulated caster stem being received in said caster bore so as to removably secure the caster assembly to the base.

2. The article of claim 1, wherein the caster stem has a top, the caster socket has a closed top end, and an empty chamber is located between the top of the caster stem and the closed top end of the caster socket.

3. The article of claim 1, wherein the caster stem is formed of metal, and the polymer friction sleeve prevents the metal caster stem from having metal-to-metal contact.

4. The article of claim 1, wherein the friction sleeve covers the caster stem entirely except at the friction sleeve's slot and open top.

5. The article of claim 1, wherein caster stem has a collar and a top, the friction sleeve extending from the caster stem's collar to adjacent the top of the caster stem.

6. The article of claim 1, wherein the friction sleeve has a composition and configuration that provide the friction sleeve with a resiliency that keeps it in frictional engagement with the caster socket such that a removal force of at least 5 lbf is required to separate the sleeve-encapsulated caster stem from the caster socket.

7. The article of claim 6, wherein the removal force of at least 5 lbf is required to separate the sleeve-encapsulated caster stem from the caster socket after subjecting the article to a caster durability test as defined by ANSI/BIFMA X5.1-2002, Section 17.

8. The article of claim 1, wherein the detents comprise a channel formed in the caster stem and at least one male detent projecting radially inwardly from the friction sleeve.

9. The article of claim 1, wherein the base is a leg of a chair.

10. The article of claim 1, wherein the friction sleeve is a cylinder with an open top and an open bottom, the slot being in only one side of the cylinder.

11. The article of claim 1, wherein the friction sleeve has a tapered leading end region defining a first end of the friction sleeve.

12. The article of claim 11, wherein the friction sleeve also has a tapered trailing end region.

13. The article of claim 1, wherein the friction sleeve has a diameter, the friction sleeve having a resiliency adapting it to expand and contract repeatedly so as to increase or decrease its diameter after which the friction sleeve springs back to its original form.

14. The article of claim 1, wherein the friction sleeve has a wall thickness of less than 0.1 inch.

15. An article movable by rolling, the article comprising:
a base having a caster bore; and
a caster assembly, the caster assembly comprising at least one wheel, a frame member, a caster stem, and a friction sleeve, the friction sleeve defining a first end and a second end between which extends an axial length of the friction sleeve, the first and second ends of the friction sleeve both being open, the friction sleeve comprising a polymer and encapsulating substantially the entire axial length of the caster stem, such that the friction sleeve prevents contact between the caster stem and the base, the friction sleeve having a generally cylindrical interior configuration and defining a slot, the slot extending along the entire axial length of the friction sleeve, the caster stem and the friction sleeve having engaged detents securing the friction sleeve on the caster stem, the resulting sleeve-encapsulated caster stem being received in the caster bore such that the friction sleeve directly engages the base so as to removably secure the caster assembly to the base, wherein there is no caster socket between the base and the sleeve-encapsulated caster stem.

16. The article of claim 15, wherein the base has walls bounding the caster bore, the caster stem has a top, and the top of the caster stem is spaced from the walls bounding the caster bore.

17. The article of claim 15, wherein the friction sleeve covers the caster stem entirely except at the friction sleeve's slot and open top.

18. The article of claim 15, wherein the caster stem is formed of metal, and the polymer friction sleeve prevents the metal caster stem from having metal-to-metal contact.

19. The article of claim 15, wherein caster stem has a collar and a top, the friction sleeve extending from the caster stem's collar to adjacent the top of the caster stem.

20. The article of claim 15, wherein the caster stem is devoid of any metal friction ring.

21. The article of claim 15, wherein the base is a leg of a chair.

22. The article of claim 15, wherein the friction sleeve comprises a plurality of fins projecting radially outward to contact the base.
